(19) United States
(12) Patent Application Publication
(10) Pub. No.: US 2026/0249313 A1
(43) Pub. Date: Aug. 27, 2026

(54) SPRINKLER SYSTEM FOR IRRIGATING ZONES WITH DIFFERENT SPRAY PATTERNS

(71) Applicant: CANADIAN TIRE CORPORATION, LIMITED, Toronto (CA)

(72) Inventors: Cong LI, Toronto (CA); Samuel CHENG, East York (CA); Abdul Haleem Ahamed KOYA, Oakville (CA); Christopher PEAREN, Brampton (CA); Ron THATCHER, Bond Head (CA); Bartek ZALEWSKI, Newmarket (CA)

(21) Appl. No.: 19/546,814

(22) Filed: Feb. 23, 2026

Related U.S. Application Data
(60) Provisional application No. 63/763,356, filed on Feb. 26, 2025.

(51) Int. Cl. B05B 1/12; B05B 12/00; B05B 15/622

(52) U.S. Cl. CPC B05B 1/12; B05B 12/002; B05B 15/622

(57) ABSTRACT

Sprinkler systems and irrigation methods are provided. A sprinkler system for irrigating zones with different spray patterns includes a sprinkler head releasably connectable to a first controller and a second controller. The sprinkler head includes an interface for receiving: a first input causing the sprinkler head to irrigate with a first spray pattern; and a second input causing the sprinkler head to irrigate with a second spray pattern different from the first spray pattern. The first controller stores the first input provides the first input to the sprinkler head to cause the sprinkler head to irrigate with the first spray pattern during irrigation of a first zone. The second controller stores the second input and provides the second input to the sprinkler head to cause the sprinkler head to irrigate with the second spray pattern during irrigation of a second zone.

### CROSS-REFERENCE TO RELATED APPLICATION(S) AND CLAIM OF PRIORITY

The present application claims priority to U.S. provisional patent application no. 63/763,356 filed on February 26, 2025, the entire contents of which are hereby incorporated herein by reference.

### TECHNICAL FIELD

The disclosure relates generally to irrigation and more particularly to irrigation sprinkler systems for irrigating zones with different spray patterns.

### BACKGROUND

When irrigating a lawn or garden, a homeowner may move an adjustable sprinkler to different locations to irrigate different zones of the yard. The zones may have different shapes and require the spray pattern of the sprinkler to be adjusted to provide the required coverage for each zone. Adjusting the spray pattern of an adjustable sprinkler can require trial and error and can be time consuming. During the adjustment process, the homeowner may inadvertently get sprayed with water. Achieving the desired coverage for the different zones of the yard while avoiding irrigating areas that do not need irrigation (e.g., street, driveway, patio, sidewalk and house) can be challenging. Improvement is desirable.

### SUMMARY

In one aspect, the disclosure describes a sprinkler system for irrigating zones with different spray patterns. The sprinkler system includes:

a sprinkler head connectable to a water source, the sprinkler head including an interface for receiving: a first input causing the sprinkler head to irrigate with a first spray pattern; and a second input causing the sprinkler head to irrigate with a second spray pattern different from the first spray pattern;

a first controller storing the first input and being releasably connectable to the sprinkler head to provide the first input to the sprinkler head via the interface and cause the sprinkler head to irrigate with the first spray pattern during irrigation of a first zone; and

a second controller storing the second input and being releasably connectable to the sprinkler head to provide the second input to the sprinkler head via the interface and cause the sprinkler head to irrigate with the second spray pattern during irrigation of a second zone.

The sprinkler system may include: a first base configured to hold the first controller at a first location for irrigating the first zone, the first base including a first anchor for engaging with a ground at the first location; and a second base configured to hold the second controller at a second location for irrigating the second zone, the second base including a second anchor for engaging with a ground at the second location.

The first base may include a platform including an upper side facing the first controller, and a lower side opposite the upper side. The first anchor may include a spike extending from the lower side of the platform.

The first controller may be releasably connectable to the first base.

The first controller may be releasably connectable to the first base via a stem and socket coupling.

The interface of the sprinkler head may include a cam follower operable to adjust a spray distance of the sprinkler head. The first input of the first controller may include a first cam surface for interacting with the cam follower of the sprinkler head. The second input of the second controller may include a second cam surface for interacting with the cam follower of the sprinkler head.

The first cam surface of the first controller may be manually adjustable to adjust the spray distance.

The sprinkler head may include a handle for manually adjusting the first cam surface of the first controller.

The sprinkler head may be rotatable about a sprinkler axis when the sprinkler head is releasably connected to the first controller. The first cam surface may be radially adjustable relative to the sprinkler axis.

The first cam surface may include a circular disk that is eccentrically mounted to the first controller.

The sprinkler head may be connectable to the water source via the first base when the first base is holding the first controller and the sprinkler head is releasably connected to the first controller.

The sprinkler head may be connectable to the water source via the second base when the second base is holding the second controller and the sprinkler head is releasably connected to the second controller.

The first controller may include a plurality of guides angularly spaced apart about the sprinkler axis. The guides may be radially adjustable relative to the sprinkler axis.

The first cam surface may include a belt extending at least partially around the sprinkler axis and interacting with the guides so that a profile of the first cam surface is defined by the guides.

One or more of the guides may each include a linear gear. The first controller may include a manually rotatable pinion gear that is meshed with the linear gear to drive a radial translation of the first guide relative to the sprinkler axis.

The sprinkler head may include arc adjustment rings defining an angular range of rotation of the sprinkler head.

Embodiments may include combinations of the above features.

In another aspect, the disclosure describes a method of irrigating zones with different spray patterns. The method includes:

irrigating a first zone with a sprinkler head while the sprinkler head is docked to a first docking station, the first docking station providing a first input to the sprinkler head to cause the sprinkler head to irrigate the first zone with a first spray pattern; and

irrigating a second zone with the sprinkler head while the sprinkler head is docked to a second docking station, the second docking station providing a second input to the sprinkler head to cause the sprinkler head to irrigate the second zone with a second spray pattern different from the first spray pattern.

The method may include adjusting the first input stored in the first docking station while the sprinkler head is docked to the first docking station using a user interface disposed on the sprinkler head.

The method may include adjusting the second input stored in the second docking station while the sprinkler head is docked to the second docking station using the user interface disposed on the sprinkler head.

The first input may include a cam surface disposed on the first docking station for interacting with a cam follower of the sprinkler head.

Embodiments may include combinations of the above features.

In a further aspect, the disclosure describes a sprinkler system for irrigating a zone. The sprinkler system includes:

a docking station configured for installation at a location associated with the zone, the docking station storing a definition of a spray pattern for irrigating the zone; and

a sprinkler head connectable to a water source and releasably connectable to the docking station, the sprinkler head including an interface operable to receive the definition of the spray pattern from the docking station to irrigate the zone with the sprinkler head according to the definition of the spray pattern.

The docking station may include an anchor for engaging with a ground, and a controller storing the definition of the spray pattern.

The docking station may include a platform including an upper side facing the controller, and a lower side opposite the upper side. The anchor may include a spike extending from the lower side of the platform. The platform may extend radially outwardly beyond the controller relative to the spike.

The docking station may include a cam surface storing the definition of the spray pattern. The interface of the sprinkler head may include a cam follower for interacting with the cam surface of the docking station. The cam follower being operable to adjust a spray distance of the sprinkler head.

The definition of the spray pattern stored in the docking station may be adjustable via a user interface disposed on the sprinkler head.

The sprinkler head may be releasably connectable to the docking station via a stem and socket coupling.

The docking station may include a cam surface having an adjustable profile providing the definition of the spray pattern. The cam surface may include a belt extending across a plurality of guides. Each guide may include a linear gear meshed with a pinion gear. The pinion gear may be rotatable to cause a translation of each guide to adjust the profile of the cam surface.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic representation of an exemplary irrigation sprinkler system for irrigating zones requiring different spray patterns;

FIG. 2 is an aerial view of an exemplary parcel of land including a house and two zones of different shapes to be irrigated;

FIG. 3 is a flow diagram illustrating a method of irrigating zones with different spray patterns;

FIG. 4A is an aerial view of part of the parcel of land of FIG. 2 showing a first zone being irrigated using the sprinkler system of FIG. 1;

FIG. 4B is an aerial view of another part of the parcel of land of FIG. 2 showing a second zone being irrigated using the sprinkler system of FIG. 1;

FIGS. 5A and 5B are perspective views of another exemplary sprinkler system;

FIG. 6 is a top plan view of cam surfaces of a controller of the sprinkler system of FIG. 5A configured to store a spray pattern;

FIG. 7 is a perspective view of an exemplary sprinkler head of the sprinkler system of FIG. 5A;

FIGS. 8A and 8B are perspective views of an exemplary docking station of the sprinkler system of FIG. 5A in an assembled state and in a disassembled state respectively;

FIG. 9 is a perspective view of another sprinkler system including a sprinkler head and two docking stations;

FIG. 10 is a perspective view of another sprinkler system including a sprinkler head and two docking stations;

FIG. 11 is a perspective view of an exemplary sprinkler head and an exemplary docking station of the sprinkler system of FIG. 10 in a disassembled state;

FIG. 12 is a schematic cross-sectional view of part of the sprinkler head and part of the docking station of the sprinkler system of FIG. 10 taken along line 12-12 in FIG. 10;

FIG. 13 is a perspective view of an exemplary docking station of the sprinkler system of FIG. 10 with a cover thereof removed;

FIG. 14 is an enlarged perspective view of part of the docking station of FIG. 13; and

FIG. 15 is an enlarged perspective view of part of the sprinkler head of FIG. 10 including arc adjustment rings.

### DETAILED DESCRIPTION

This disclosure describes irrigation sprinkler systems and methods for facilitating the irrigation of zones of different shapes and/or sizes with different spray patterns. The sprinkler systems and methods described herein may be used to irrigate lawns, gardens, agricultural crops and golf courses for example. A "zone" as referenced herein encompasses an area of land that is irrigated (i.e., supplied with water) to foster plant growth. The sprinkler systems and methods described herein may be suitable for residential, industrial and agricultural usages.

In various embodiments, the sprinkler systems described herein may include a sprinkler head that may be docked to a first docking station for irrigating a first zone and then docked to a second docking station for irrigating a second zone. The first docking station may store a first spray pattern that is executed by the sprinkler head to irrigate the first zone. The second docking station may store a second spray pattern that is executed by the sprinkler head to irrigate the second zone. By having the applicable spray pattern stored in the corresponding docking station, the same sprinkler head may be used to irrigate a plurality of zones without having to manually adjust the spray pattern each time the sprinkler head is moved to a different zone. In some embodiments, the sprinkler systems described herein may promote ease of use and consistency of irrigation coverage of zones of different shapes and/or sizes.

Aspects of various embodiments are described through reference to the drawings. The terms "connected" and "docked" may include both direct connection and docking (in which two elements contact each other) and indirect connection and docking (in which at least one additional element is located between the two elements).

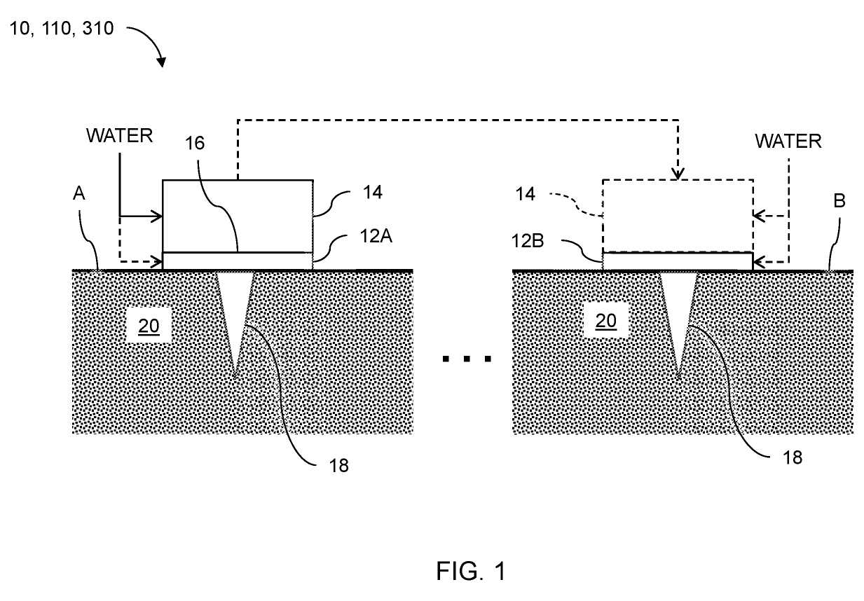

FIG. 1 is a schematic representation of an exemplary sprinkler system 10 for irrigating zones requiring different spray patterns. Sprinkler system 10 may be used to irrigate zone A, zone B and/or other zones. Sprinkler system 10 may include first docking station 12A configured for installation at a first location associated with zone A. First docking station 12A may store a definition of a first spray pattern suitable for irrigating zone A. Sprinkler system 10 may optionally include one or more second docking stations 12B (referred hereinafter in the singular) configured for installation at a second location associated with zone B (or other zone(s)). Second docking station 12B may store a definition of a second spray pattern suitable for irrigating zone B. Two docking stations are illustrated herein as an example but sprinkler system 10 may include three or more docking stations for irrigating additional zones if required.

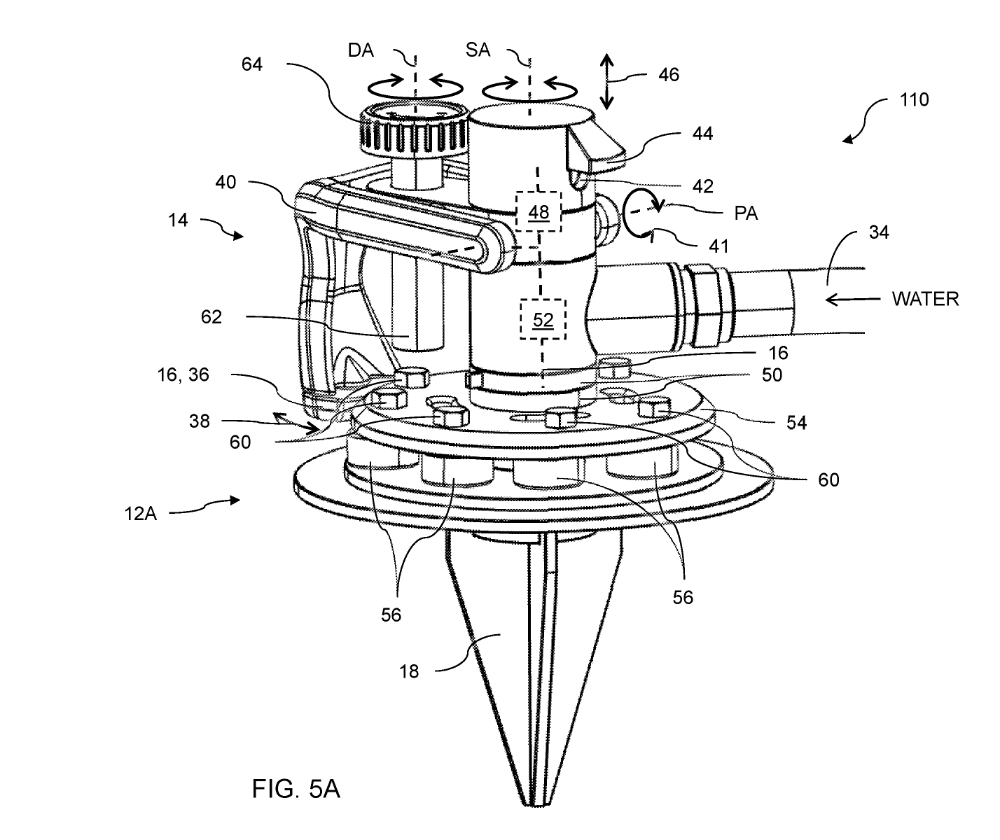

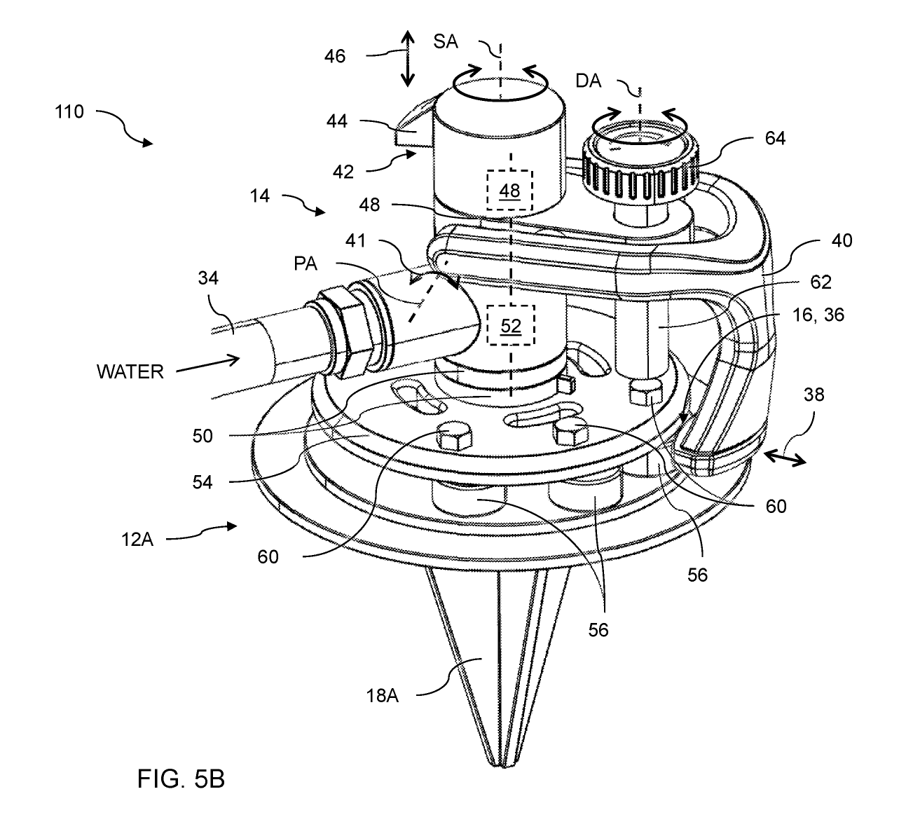

Sprinkler system 10 may include sprinkler head 14, which may be connectable to a water source and configured to dispense water according to a spray pattern that is stored in first docking station 12A or in second docking station 12B. Sprinkler head 14 may be connectable to the water source via hose 34 (shown in FIG. 5A) directly connectable to sprinkler head 14. Alternatively, sprinkler head 14 may be connectable to the water source via docking station(s) 12A, 12B by way of hose 34 being directly connectable to docking station(s) 12A, 12B. Sprinkler head 14 may be releasably connectable to first docking station 12A as shown in solid lines in FIG. 1, and to second docking station 12B as shown in broken lines in FIG. 1. Sprinkler head 14 may include interface 16 operable to receive the definition of the spray pattern stored in first docking station 12A or in second docking station 12B when sprinkler head 14 is releasably connected (i.e., docked) to first docking station 12A or to second docking station 12B respectively. When connected to a water source and docked to first docking station 12A or to second docking station 12B, sprinkler head 14 may dispense water according to the spray pattern that is stored in the applicable first docking station 12A or second docking station 12B.

In some embodiments, docking stations 12A, 12B may each include anchor 18 for engaging with ground 20 to hold docking stations 12A, 12B (and sprinkler head 14 connected thereto) in place during irrigation. In some embodiments, anchors 18 may each include a spike that is insertable into ground 20. The installation of docking stations 12A, 12B may be performed by the user manually engaging anchors 18 into ground 20 at their respective desired locations by pressing docking stations 12A, 12B downward with their hand or foot. For example, a user may step on docking stations 12A, 12B to cause anchors 18 to engage ground 20. In various embodiments, docking stations 12A, 12B may be suitable for installation entirely below the ground level, flush with the ground level and/or have part(s) of docking stations 12A, 12B protruding above the ground level. In some embodiments, docking stations 12A, 12B may be configured to have a relatively small protruding height above the ground level to be less obtrusive and prevent interference with a lawn mower blade for example.

As explained below, docking stations 12A, 12B may be reconfigurable (i.e., programmable, adjustable) so that a user of sprinkler system 10 may selectively configure (i.e., program, adjust) docking stations 12A, 12B with their respective spray patterns suitable for irrigating zones A and B respectively. In other words, docking stations 12A, 12B may be programmable memory modules that can store respective spray patterns. The configuration of docking stations 12A, 12B may be performed while docking stations 12A, 12B are installed at their appropriate locations for irrigating zones A, B respectively. In some situations, docking stations 12A, 12B or part(s) thereof may be permanently or semi-permanently (e.g., for a season) installed at their respective irrigation locations. When irrigation of zone A is desired, the user may dock sprinkler head 14 to first docking station 12A so that sprinkler head 14 may irrigate zone A using the spray pattern retrieved from first docking station 12A. When irrigation of zone B is desired, the user may dock the same sprinkler head 14 to second docking station 12B so that sprinkler head 14 may irrigate zone B using the spray pattern retrieved from second docking station 12B.

When neither zone A nor zone B are being irrigated, sprinkler head 14 may be stored at a suitable location (e.g., garage, shed) remote from docking stations 12A, 12B. If desired, docking stations 12A, 12B may be left at their suitable respective locations for irrigating zone A and zone B even when no irrigation is being performed, and remain ready for the next irrigation cycle. The use of programmable docking stations 12A, 12B may reduce or eliminate the need for spray pattern adjustments between irrigations and also when switching between irrigating zone A and irrigating zone B.

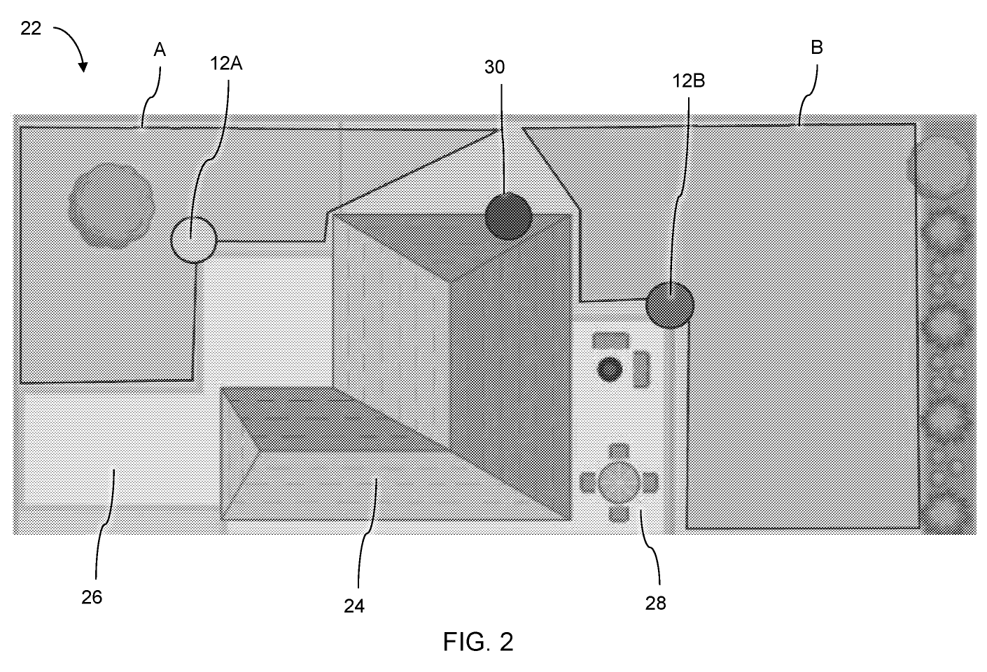

FIG. 2 is an aerial view of an exemplary parcel of land 22 including house 24, driveway 26 and patio 28, which do not require irrigation. Parcel of land 22 may include two or more zones A, B of different shapes and/or sizes to be irrigated. Zone A may be a front yard including grass, one or more trees and/or other plants. Zone B may be a back yard including grass, one or more trees and/or other plants. The water source may be an outdoor water faucet at location 30 to which hose 34 may be connected.

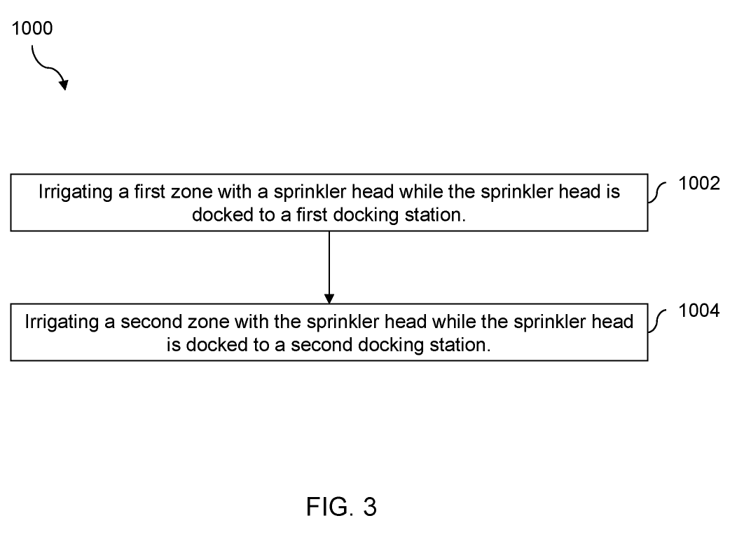

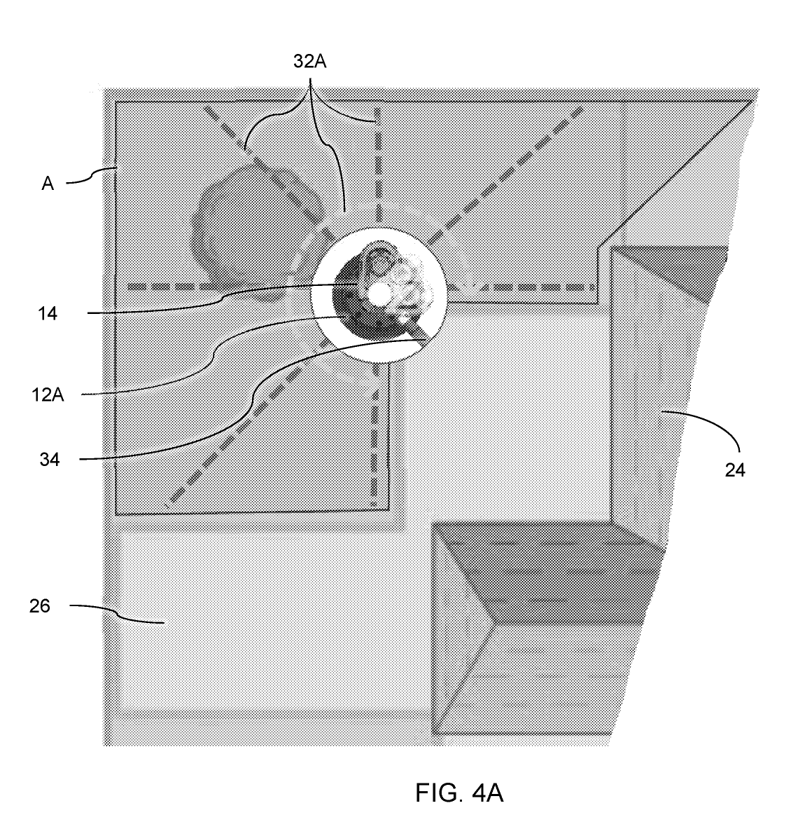

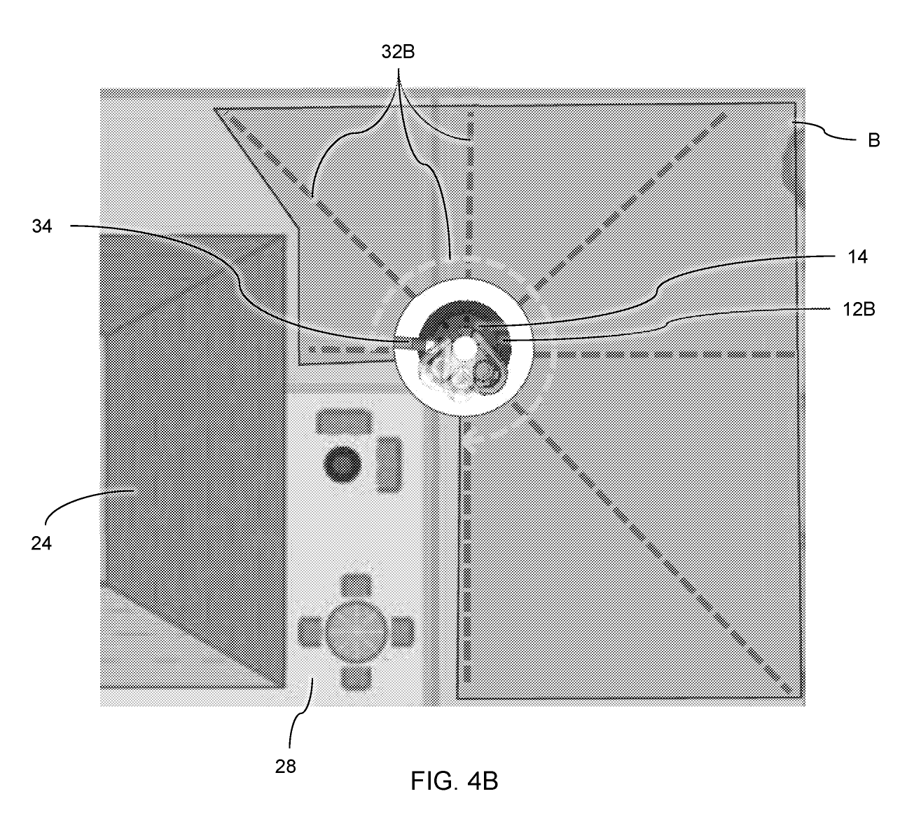

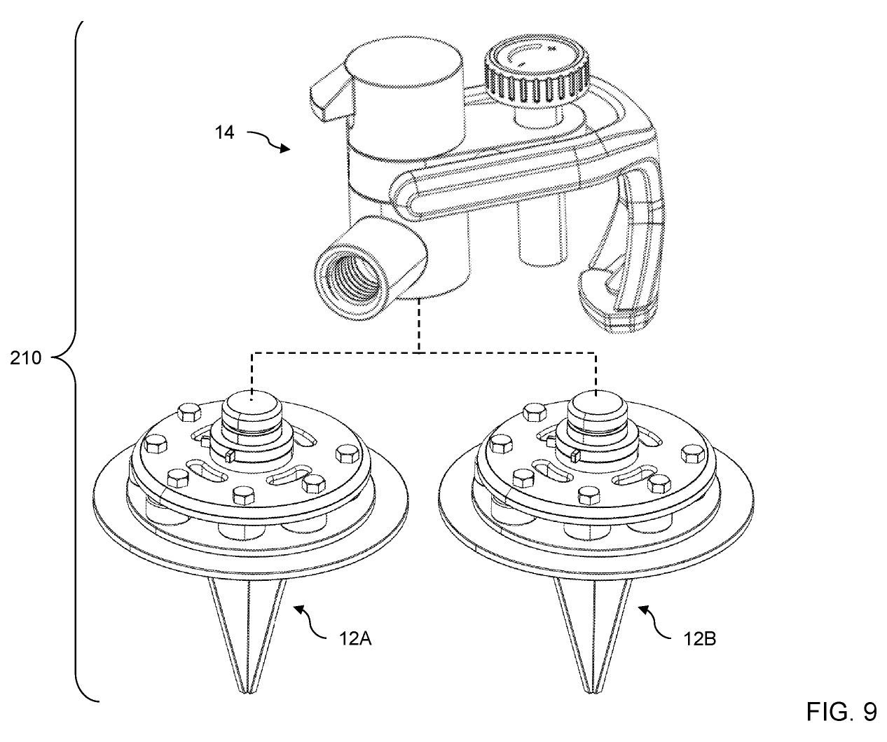

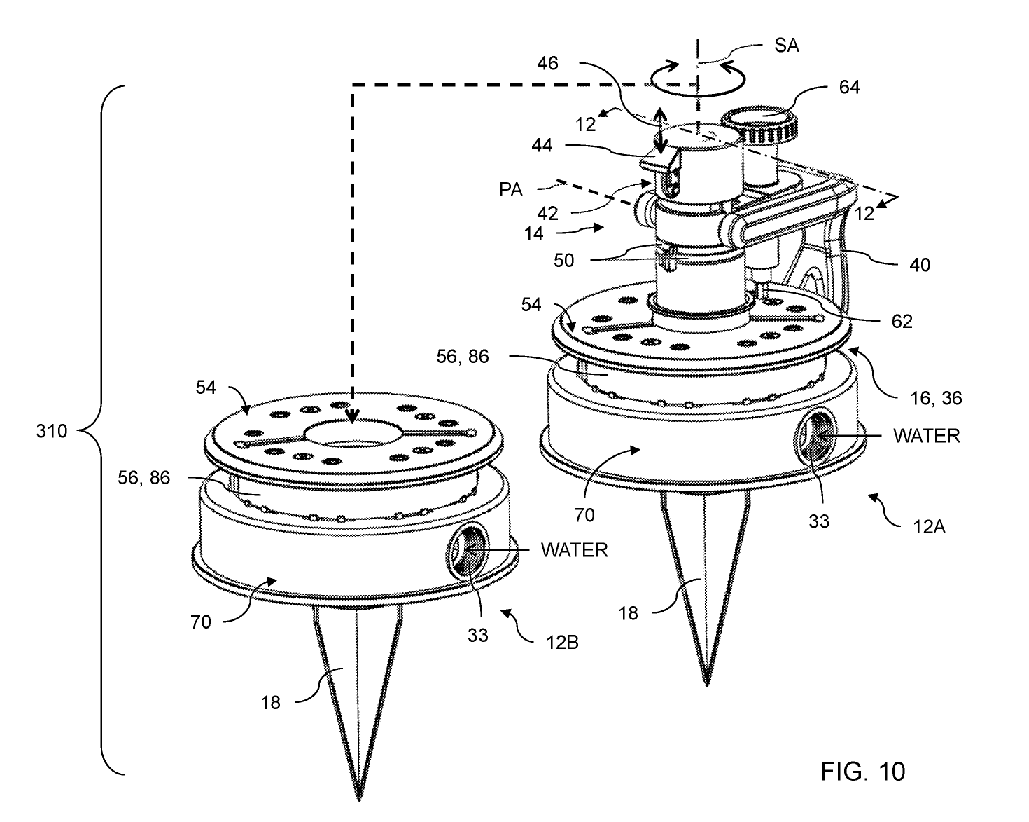

FIG. 3 is a flow diagram illustrating a method 1000 of irrigating zones A, B with different respective spray patterns 32A, 32B, which are illustrated in FIGS. 4A and 4B respectively. Method 1000 may be performed using sprinkler system 10, sprinkler system 110 (shown in FIGS. 5A and 5B), sprinkler system 210 (shown in FIG. 9), sprinkler system 310 (shown in FIG. 10) or using another suitable sprinkler system. Method 1000 may be combined with other actions disclosed herein and/or may include elements of sprinkler systems 10, 110, 210, 310. In various embodiments, method 1000 may include:

irrigating first zone A with sprinkler head 14 while sprinkler head 14 is docked to first docking station 12A (block 1002); and

irrigating second zone B with sprinkler head 14 while sprinkler head 14 is docked to second docking station 12B (block 1004).

In some embodiments of method 1000, first docking station 12A may provide a first input to sprinkler head 14 via interface 16 to cause sprinkler head 14 to irrigate zone A with first spray pattern 32A stored in first docking station 12A. In some embodiments of method 1000, second docking station 12B may provide a second input to sprinkler head 14 via interface 16 to cause sprinkler head 14 to irrigate zone B with second spray pattern 32B stored in second docking station 12B and different from first spray pattern 32A.

In some embodiments, method 1000 may include docking sprinkler head 14 to first docking station 12A located at a first location. First docking station 12A may store the first input for sprinkler head 14 defining first spray pattern 32A tailored for zone A. After irrigating zone A and before irrigating zone B, method 1000 may include undocking sprinkler head 14 from first docking station 12A and docking sprinkler head 14 to second docking station 12B located at a second location. Second docking station 12B may store the second input for sprinkler head 14 defining second spray pattern 32B tailored for zone B.

In some embodiments, method 1000 may include adjusting first spray pattern 32A and/or second spray pattern 32B that are stored in respective first docking station 12A and/or second docking station 12B. Such adjustment may be performed during initial installation and setup of first docking station 12A and/or second docking station 12B and may remain available and valid for one or more subsequent irrigation cycles. Further aspects of method 1000 and of sprinkler systems 10, 110, 210, 310 are described below in reference to the subsequent figures.

FIG. 4A is an aerial view of part of the parcel of land 22 of FIG. 2 including zone A being irrigated using sprinkler system 10, 110, 210, 310. Sprinkler head 14 is docked to first docking station 12A and is connected to the water source via hose 34. FIG. 4A shows an enlarged representation of sprinkler head 14 and first docking station 12A for illustration purpose. First spray pattern 32A may be tailored for the shape and size of zone A and for dispensing water from the location of first docking station 12A. The definition of first spray pattern 32A that is stored in first docking station 12A may optionally include an arc defining an angular range of rotation of sprinkler head 14 applicable to zone A. The definition of first spray pattern 32A may include one or more radial spray distances defined along the arc. For example, first spray pattern 32A may include a plurality of radial spray distances angularly spaced apart along the arc.

FIG. 4B is an aerial view of another part of the parcel of land 22 of FIG. 2 including zone B being irrigated using sprinkler system 10, 110, 210, 310. Sprinkler head 14 is docked to second docking station 12B and is connected to the water source via hose 34. FIG. 4B shows an enlarged representation of sprinkler head 14 and second docking station 12B for illustration purpose. Second spray pattern 32B may be tailored for the shape and size of zone B and for dispensing water from the location of second docking station 12B. The definition of second spray pattern 32B that is stored in second docking station 12B may optionally include an arc defining an angular range of rotation of sprinkler head 14 applicable to zone B. The definition of second spray pattern 32B may include one or more radial spray distances defined along the arc. For example, second spray pattern 32B may include a plurality of radial spray distances angularly spaced apart along the arc.

FIGS. 5A and 5B are perspective views of another exemplary sprinkler system 110 for irrigating zones A, B requiring different spray patterns 32A, 32B. Sprinkler system 110 may include elements of sprinkler system 10 previously described above and like elements are identified using like reference numerals. FIGS. 5A and 5B show sprinkler system 110 as including first docking station 12A and sprinkler head 14 being docked to first docking station 12A. For the sake of conciseness, only first docking station 12A is described in detail below, however, the description of first docking station 12A is also applicable to second docking station 12B. In some embodiments, first docking station 12A and second docking station 12B may have an identical construction and be independently programmable to store their respective different spray patterns.

Sprinkler head 14 may be connectable to a water source via hose 34. In some embodiments, a manually actuatable shut-off valve may be operatively disposed between sprinkler head 14 and hose 34 to facilitate set-up of system 110. Sprinkler head 14 may include interface 16, for receiving (retrieving) a first input causing sprinkler head 14 to irrigate with first spray pattern 32A, or for receiving (retrieving) a second input causing sprinkler head 14 to irrigate with second spray pattern 32B different from first spray pattern 32A. In some embodiments, interface 16 may include cam follower 36 but other types of (e.g., mechanical) interfaces for receiving different types of inputs may be suitable. Cam follower 36 may be movable in a reciprocating manner along arrow 38 and may be disposed at a distal end of arm 40 that is pivotally connected to a body of sprinkler head 14 and rotatable in a reciprocating manner about pivot axis PA as shown by arrow 41. The movement of cam follower 36 along arrow 38 may cause arm 40 to rotate about pivot axis PA along arrow 41.

Sprinkler head 14 may include nozzle 42 through which water is dispensed during irrigation. Sprinkler head 14 may also include deflector 44 that may interact with the jet of water exiting nozzle 42 and that may be movable to adjust a spray distance of the water that is dispensed via nozzle 42. Deflector 44 may be movable (e.g., vertically) along arrow 46 relative to nozzle 42. Deflector 44 may be drivingly connected to arm 40 via suitable distance mechanism 48 (shown schematically) so that rotation of arm 40 may drive movement of deflector 44 vertically along arrow 46. In the embodiment shown, upward movement of deflector 44 relative to nozzle 42 may reduce the interference of deflector 44 with the jet of water exiting nozzle 42 and may result in increasing the spray distance. On the other hand, downward movement of deflector 44 relative to nozzle 42 may increase the interference of deflector 44 with the jet of water exiting nozzle 42 and may result in reducing the spray distance.

Distance mechanism 48 may include any suitable arrangement that converts rotary motion of arm 40 about pivot axis PA into linear motion of deflector 44 along arrow 46. In some embodiments, distance mechanism 48 may include a circular pinion gear rotatable with arm 40 and that is meshed with a linear gear (i.e., rack) that is translatable with deflector 44 along arrow 46. In various embodiments, distance mechanism 48 may include one or more gears and/or one or more linkages.

During operation of sprinkler system 110, sprinkler head 14 (e.g., including arm 40, cam follower 36, nozzle 42 and deflector 44) may rotate about sprinkler axis SA back-and-forth through an arc that is defined via one or more arc adjustment rings 50 or other suitable adjustment mechanism. For example, two arc adjustment rings 50 may be part of first docking station 12A and may be manually adjustable by the user. The angular positions of arc adjustment rings 50 about sprinkler axis SA may be manually adjustable to set the limits of an angular span for the first spray pattern 32A. One arc adjustment ring 50 may serve to set one limit of the angular span and the other arc adjustment ring 50 may server to set another (i.e., opposite) limit of the angular span. Arc adjustment rings 50 may frictionally retain their respective positions after adjustment.

Rotation of sprinkler head 14 may be driven by a suitable (e.g., gear, impact or other) drive mechanism 52 (shown schematically). In some embodiments, drive mechanism 52 may include a rotor rotationally driven by water flowing through sprinkler head 14. Drive mechanism 52 may have a valve disposable in two positions to control flow to the rotor to determine the direction in which the rotor rotates to cause corresponding rotation of sprinkler head 14. Sprinkler head 14 may be rotatable in a full or partial circle about sprinkler axis SA. Arc adjustment rings 50 may be operatively connected to (e.g., the valve of) drive mechanism 52 via a suitable interface 16 (e.g., gear(s), linkage) to define desired limits for the angular span of sprinkler head 14 during irrigation. Connector 33 establishing liquid communication between hose 34 and sprinkler head 14 may remain stationary and not rotate with the rest of sprinkler head 14 in some embodiments.

First docking station 12A may include controller 54 storing the first input as a definition of first spray pattern 32A. Controller 54 may be releasably connectable to sprinkler head 14 to provide the first input to sprinkler head 14 via interface 16 and cause sprinkler head 14 to irrigate with first spray pattern 32A during irrigation of zone A. Arc adjustment rings 50 may be part of controller 54 and hence may partially define first spray pattern 32A stored in first docking station 12A. Alternatively, arc adjustment rings 50 may be part of sprinkler head 14.

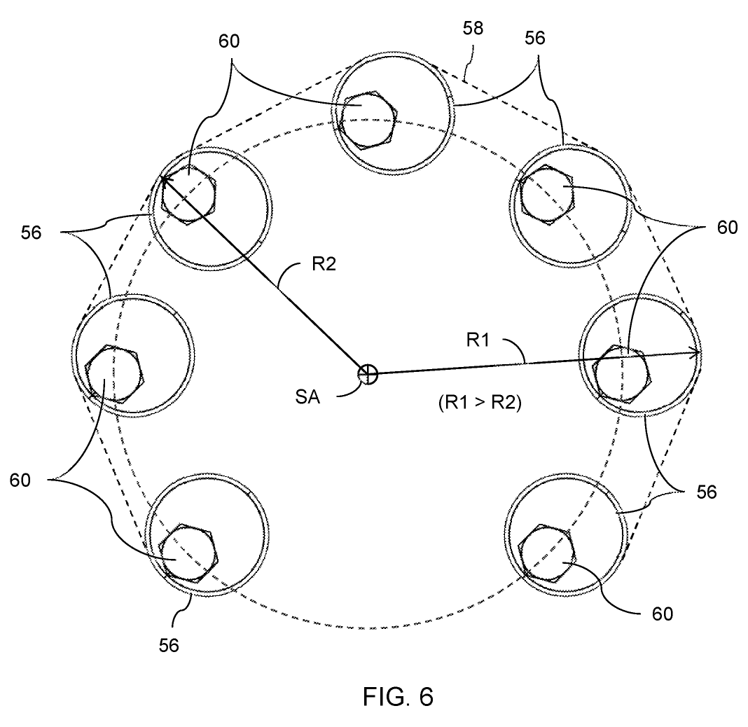

Controller 54 may include (i.e., store) a definition of one or more spray distances defined at one or more angular positions about sprinkler axis SA. The spray distance(s) may be defined by the positions of one or more cam surfaces 56 that are disposed in controller 54. Cam surfaces 56 may cooperatively define a cam profile such as track 58 (shown in FIG. 6) that extends partially or fully about sprinkler axis SA and that is stationary relative to sprinkler head 14. Cam follower 36 may interact with (e.g., glide along) track 58 as cam follower 36 rotates about sprinkler axis SA during irrigation. The trajectory of track 58 may define the spray distances.

In various embodiments, interface 16 may include one or more communication paths between sprinkler head 14 and first docking station 12A. For example, a first communication path (e.g., via cam follower 36) may transfer spray distances represented by cam surfaces 56 to sprinkler head 14. Alternatively or in addition, an optional second communication path (e.g., via drive mechanism 52) may transfer an angular span represented by arc adjustment rings 50 to sprinkler head 14.

In some embodiments, cam surfaces 56 may alternatively define an adjustable axially variable (e.g., roller coaster type) track that extends partially or fully around sprinkler axis SA, and that has a height parallel to sprinkler axis SA that varies as a function of the angular position around sprinkler axis SA. In such embodiments, cam follower 36 may be configured to convert such axial variations along the track into rotational movement about pivot axis PA to adjust the spray distance as a function of the angular position of sprinkler head 14. In other embodiments as shown in FIGS. 5A, 5B, 6 and 13 as examples, cam surfaces 56 may define a radially adjustable track 58 (cam profile) that has a radial distance transverse to sprinkler axis SA that varies as a function of the angular position. In such embodiments, cam follower 36 may be configured to convert such radial variations along track 58 into rotational movement about pivot axis PA to adjust the spray distance as a function of the angular position of sprinkler head 14.

Cam surfaces 56 may include respective adjustable circular disks that are eccentrically mounted to controller 54. Cam surfaces 56 may be manually adjustable by the user to store the desired spray pattern in first docking station 12A. Cam surfaces 56 may be retained between upper and lower plates of controller 54 by way of respective bolts 60 or other fastener(s). The circular disks that define cam surfaces 56 may be eccentrically mounted with respect to the axes of bolts 60. The number of cam surfaces 56 disposed about sprinkler axis SA may be selected based on the desired granularity of adjustment of the spray distances around sprinkler axis SA. In some embodiments, the angular span (i.e., width) of cam follower 36 may be wide enough to angularly span across two cam surfaces 56 to provide relatively smooth transitions of cam follower 36 from one cam surface 56 to another. In some embodiments, cam surfaces 56 may be equally distributed around an arc length about sprinkler axis SA. Arm 40 may be resiliently biased to urge cam follower 36 radially (e.g., inwardly) to maintain engagement with cam surfaces 56. Arm 40 may be resiliently biased via a suitable (e.g., rotary) spring in some embodiments.

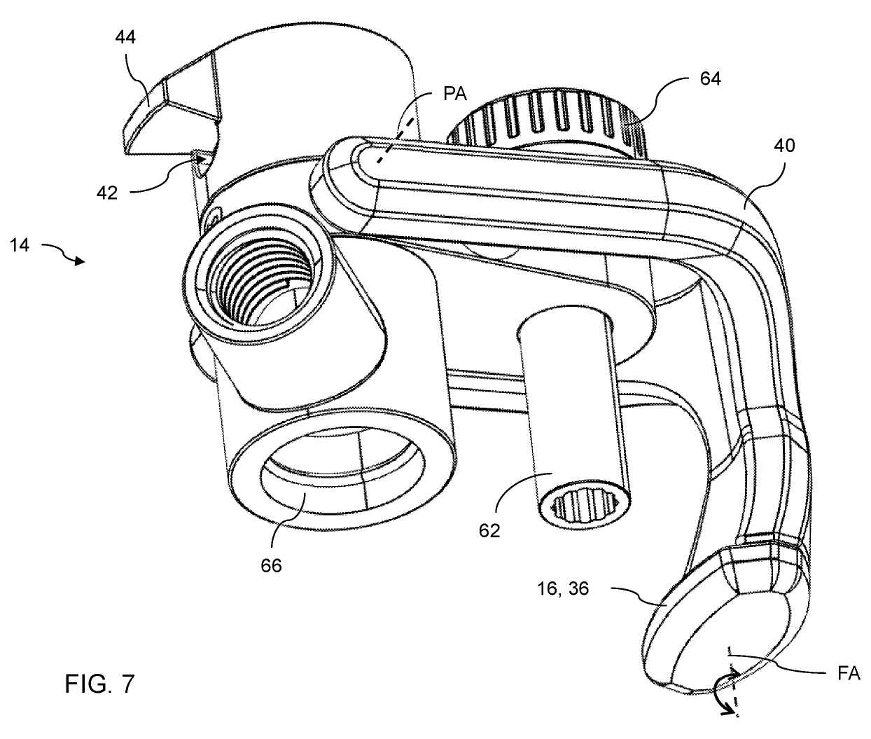

In some embodiments, cam follower 36 may be pivotally connected to arm 40 and be pivotable (e.g., within limits) relative to arm 40 about follower axis FA (shown in FIG. 7). In some embodiments, follower axis FA may be generally parallel to and offset from sprinkler axis SA. Such pivoting cam follower 36 may provide a lead-in approach when transitioning from one cam surface 56 to an adjacent cam surface 56 as arm 40 rotates about sprinkler axis SA to promote a relatively smooth transition between cam surfaces 56.

The circular disks defining respective cam surfaces 56 may be drivingly connected to the respective bolts 60 so that rotation of bolts 60 may adjust the radial positions of respective cam surfaces 56 relative to sprinkler axis SA. Cam surfaces 56 may be manually adjusted by the user by turning corresponding bolts 60, and the adjusted positions of cam surfaces 56 may be frictionally retained in controller 54 and thereby store the desired spray distances for different angular orientations of sprinkler head 14 about sprinkler axis SA.

In various embodiments, bolts 60 may be turned manually through the use of a suitable driver such as a wrench or screwdriver that is part of sprinkler head 14, or that is separate from sprinkler head 14. The adjustment of first spray pattern 32A may be performed while sprinkler head 14 is installed on first docking station 12A and dispensing water so that the spray distances corresponding to the adjusted positions of cam surfaces 56 may be tested in real-time in zone A. In some embodiments, sprinkler head 14 may incorporate built-in driver 62 to facilitate the adjustment of cam surfaces 56. Accordingly, sprinkler system 110 may be operated without the use of tools that are not part of sprinkler system 110. Driver 62 may include a socket spanner or other suitable wrench that may be selectively engaged with bolts 60. Driver 62 may be configured (i.e., shaped) to drivingly and releasably engage with heads of bolts 60. The heads of bolts 60 may be of any suitable type such as polygonal (e.g., triangular, square, pentagon, hexagon), slotted and cross-slot for example. Driver 62 and cam follower 36 may be disposed (i.e., clocked) so that driver 62 interacts with the bolt 60 associated with the cam surface 56 that is simultaneously interacting with the cam follower 36 so that adjustment of a cam surface 56 via its corresponding bolt 60 is sensed by cam follower 36 and the effect of the adjustment of cam surface 56 can immediately be witnessed by the user. For example, driver 62 may be mounted for common rotation with arm 40 about sprinkler axis SA.

The adjustment of cam surfaces 56 to adjust corresponding spray distances can be made while the user is situated behind nozzle 42 to reduce the risk of the user inadvertently getting sprayed with water during the setup of first docking station 12A. Arm 40 and driver 62 may be disposed to a side of sprinkler head 14 that is diametrically opposite to that of nozzle 42. Driver 62 may be movable axially along driver axis DA to selectively engage and disengage with respective bolts 60. Driver 62 may be resiliently biased vertically upwardly toward the disengaged position by a spring.

Handle 64 may provide a user interface that is part of sprinkler head 14 for operating driver 62. Handle 64 may be a knob drivingly connected to driver 62 and be manually depressed downward to cause engagement of driver 62 with bolts 60. Handle 64 may also be manually rotated to cause bolts 60 to be rotated by driver 62.

During setup (i.e., programming) of first docking station 12A with first spray pattern 32A, the user may install first docking station 12A at a suitable location for irrigating first zone A. The user may also dock sprinkler head 14 to first docking station 12A and turn on the water supply to sprinkler head 14. The user may then manually orient sprinkler head 14 (e.g., by overriding drive mechanism 52) to different angular orientations to align driver 62 with respective bolts 60 and adjust the radial positions of cam surfaces 56 by using driver 62 to turn bolts 60 as water is being dispensed from nozzle 42. Different bolts 60 may be adjusted to adjust corresponding spray distances at corresponding angular orientations of sprinkler head 14. The user may also manually turn arc adjustment rings 50 to set the angular span of first spray pattern 32A. The adjusted positions of cam surfaces 56 and of arc adjustment rings 50 may define first spray pattern 32A and be retained by controller 54 until another adjustment of first spray pattern 32A is made. The definition of first spray pattern 32A stored in controller 54 may be used repeatedly with sprinkler head 14 for one or more subsequent irrigation cycles. The definition of first spray pattern 32A will remain stored in controller 54 even when sprinkler head 14 is removed (i.e., undocked) from first docking station 12A.

FIG. 6 is a top plan view of cam surfaces 56 isolated from controller 54 of sprinkler system 110 configured to store spray distances of first spray pattern 32A using the shape of track 58 (i.e., cam profile) that is cooperatively defined by cam surfaces 56. The respective adjustment of cam surfaces 56 via bolts 60 may cause the radius of track 58 to vary as a function of the angular position around sprinkler axis SA. As an example, FIG. 6 shows first radius R1 of track 58 at a first angular position and second radius R2 of track 58 at a second angular position. In this particular example, first radius R1 is greater than second radius R2 due to the different radial adjustments of the corresponding cam surfaces 56. In the illustrated embodiment, track 58 is defined on a radially outer side of the disks defining cam surfaces 56. However, in other embodiments, track 58 may be defined on a radially inner side of the disks defining cam surfaces 56. Other types of adjustable cam surface(s) may be used as explained below.

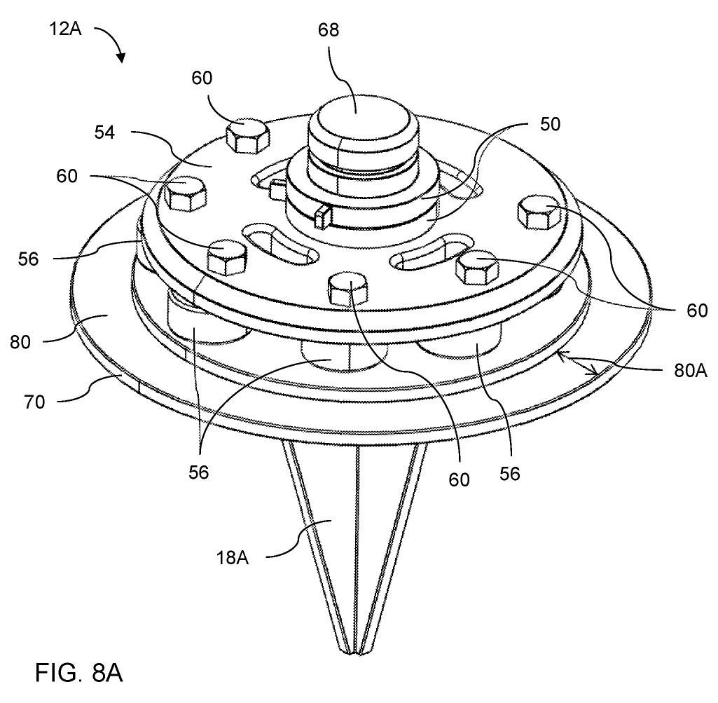

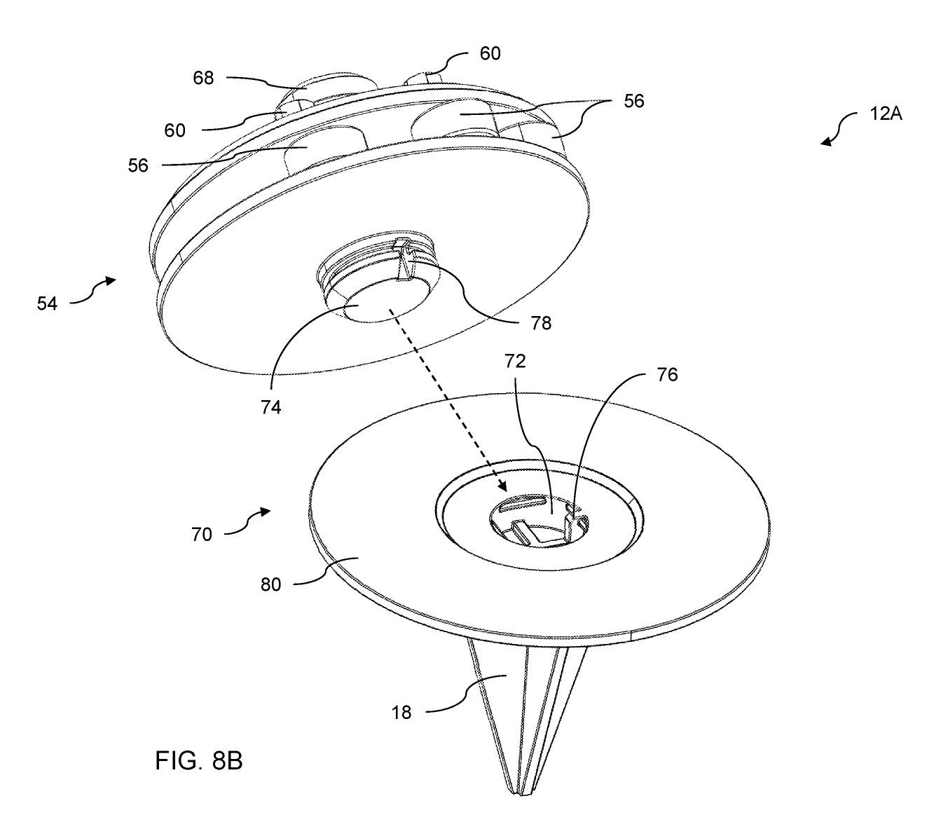

FIG. 7 is a perspective view of sprinkler head 14 of sprinkler system 110 illustrating a bottom side of sprinkler head 14. In some embodiments, sprinkler head 14 may be releasably connectable to first docking station 12A or to second docking station 12B via a releasable stem-and-socket coupling. For example, sprinkler head 14 may include socket 66 that is adapted to receive stem 68 (shown in FIG. 8A) of first docking station 12A therein. In some embodiments, the stem-and-socket coupling between sprinkler head 14 and first docking station 12A may permit rotation of sprinkler head 14 relative to first docking station 12A. In some embodiments, socket 66 and stem 68 may include one or more releasable interlocking features (e.g., ridge, groove, detent) that permit the stem-and-socket coupling to click together upon installation and to be released only upon the actuation of a release mechanism and/or the manual application of a threshold axial force pulling sprinkler head 14 away from first docking station 12A. In other embodiments, socket 66 may instead be part of first docking station 12A and stem 68 may instead be part of sprinkler head 14.

FIGS. 8A and 8B are perspective views of first docking station 12A of sprinkler system 110 in an assembled state and a disassembled state respectively. In some embodiments, first docking station 12A may be constructed to have controller 54 and base 70 permanently installed together as a unit. However, in some embodiments, first docking station 12A may optionally be constructed so that controller 54 is releasably connected to base 70. In the exemplary configuration of first docking station 12A shown, the removal of controller 54 may reduce the protruding height of the component(s) that remain at the irrigation location between irrigation cycles. For example, controller 54 may be removed from base 70 and stored separately or together with sprinkler head 14 in a shed or garage when not in use. Base 70 may remain installed at the irrigation location and have a relatively low protruding height that is less obtrusive.

Controller 54 may be releasably connected to base 70 with one or more fasteners or other means that retains the relative angular orientations (clocking) between controller 54 and base 70. In some embodiments, controller 54 may be releasably connectable to base 70 via a releasable stem-and-socket coupling. For example, base 70 may include socket 72 that is adapted to receive stem 74 of first docking station 12A therein. In some embodiments, the stem-and-socket coupling between controller 54 and base 70 may prevent rotation of controller 54 relative to base 70 and also to retain the desired orientation of controller 54 relative to base 70 when controller 54 is removed from base 70. As an example, base 70 may include key 76 that is intended to align with and be received in keyway 78 defined on stem 74. Various types of cooperating structural features may be suitable to retain the desired orientation of controller 54 relative to base 70.

In some embodiments, socket 72 and stem 74 may include one or more releasable interlocking features (e.g., ridge, groove, detent) that permit the stem-and- socket coupling to click together upon installation and to be released only upon the manual application of a threshold axial force pulling controller 54 away from base 70. In other embodiments, socket 72 may instead be part of controller 54 and stem 74 may instead be part of base 70.

Base 70 may include platform 80 including an upper side facing controller 54, and a lower side opposite the upper side. Anchor 18 (e.g., spike, corkscrew) may extend downwardly from the lower side of platform 80. In some embodiments, platform 80 may optionally extend radially outwardly beyond the perimeter of controller 54 to provide a peripheral platform area 80A around controller 54. Peripheral platform area 80A may hinder grass surrounding platform 80 from interfering with the operation of controller 54 in some situations. Peripheral platform area 80A may provide a radial gap between controller 54 and nearby grass for example.

FIG. 9 is a perspective view of a sprinkler system 210 including sprinkler head 14 and two or more docking stations such as first docking station 12A and second docking station 12B for example. In some embodiments, first docking station 12A and second docking station 12B may have an identical construction and be independently programmable to store different spray patterns. Sprinkler system 210 may be provided as a kit for irrigating two or more zones requiring different spray patterns.

FIG. 10 is a perspective view of another sprinkler system 310 including sprinkler head 14 and two docking stations 12A, 12B. Sprinkler head 14 is shown as being releasably docked to first docking station 12A but may be releasably docked to second docking station instead. Sprinkler system 310 may include elements from other sprinkler systems 10, 110, 210 described herein and like elements are identified using like reference numerals. In some embodiments, first docking station 12A and second docking station 12B may have substantially identical constructions. Description relating to first docking station 12A below may also apply to second docking station 12B.

First docking station 12A may include controller 54 storing the first input as a definition of first spray pattern 32A. Controller 54 may be releasably connectable to sprinkler head 14 to provide the first input to sprinkler head 14 via interface 16 and cause sprinkler head 14 to irrigate with first spray pattern 32A during irrigation of zone A. The definition of first spray pattern 32A may include one or more spray distances defined at one or more angular positions of sprinkler head 14 and nozzle 42 about sprinkler axis SA.

The spray distance(s) may be defined by the profile of adjustable cam surface 56 disposed in controller 54. Cam surface 56 may extends partially or fully about sprinkler axis SA and may be stationary relative to sprinkler head 14. Cam follower 36 may interact with (e.g., glide along) cam surface 56 as cam follower 36 and nozzle 42 rotate about sprinkler axis SA during irrigation. The radial positions of cam surface 56 at different angular positions along cam surface 56 may define the spray distances. Rotary motion of arm 40 about pivot axis PA caused by cam surface 56 may be converted into linear vertical motion of deflector 44 relative to nozzle 42 to vary the interference of deflector 44 with the jet of water exiting nozzle 42 to thereby vary the spray distance.

Arc adjustment ring(s) 50 may be part of sprinkler head 14 and may be manually adjustable by the user. Accordingly, the angular span of first spray pattern 32A may not be stored in first docking station 12A in some embodiments. The user may manually adjust arc adjustment ring(s) 50, if needed, when sprinkler head 14 is moved from first docking station 12A to second docking station 12B.

Sprinkler head 14 may be fluidly connectable to the water source via base 70 or other part of first docking station 12A when sprinkler head 14 is releasably connected to (e.g., controller 54) of first docking station 12A. Sprinkler head 14 may be fluidly connectable to the water source via base 70 or other part of second docking station 12B when sprinkler head 14 is releasably connected to (e.g., controller 54) of second docking station 12B. For example, base 70 of first docking station 12A may include (e.g., threaded) connector 33 establishing liquid communication between hose 34 and sprinkler head 14. First docking station 12A may remain stationary and not rotate with sprinkler head 14 during irrigation. Controller 54 may be fixedly or releasably connected to base 70 of first docking station 12A.

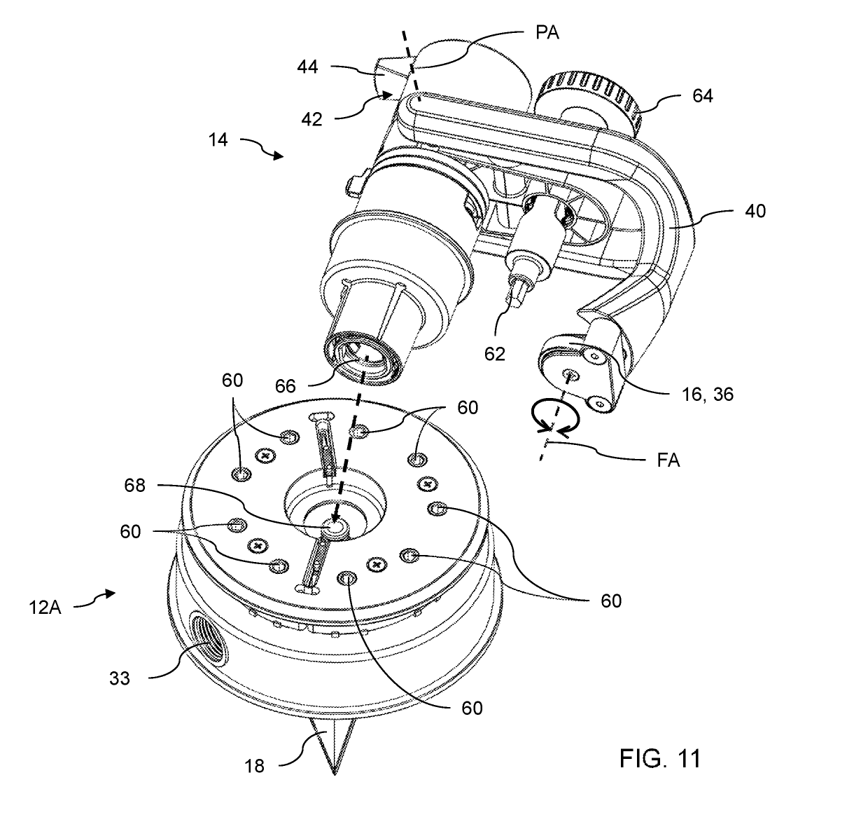

In some embodiments, sprinkler head 14 may incorporate built-in driver 62 to facilitate the adjustment of cam surface 56. Handle 64 may provide a user interface that is part of sprinkler head 14 for operating (e.g., turning) driver 62. Handle 64 may be manually depressed downward to cause engagement of driver 62 with bolts 60 (shown in FIG. 11). Handle 64 may be manually rotated to cause bolts 60 to be rotated by driver 62 to adjust the profile of cam surface 56.

FIG. 11 is a perspective view of sprinkler head 14 and first docking station 12A in a disassembled state. Sprinkler head 14 may include socket 66 that is adapted to receive stem 68 of first docking station 12A therein. Stem 68 may be recessed inside a receptacle formed in first docking station 12A. The stem-and-socket coupling between sprinkler head 14 and first docking station 12A may permit rotation of sprinkler head 14 relative to first docking station 12A. Stem 68 may include a (e.g., central) passage formed therein to establish liquid communication between connector 33 and sprinkler head 14. In other embodiments, socket 66 may instead be part of first docking station 12A and stem 68 may instead be part of sprinkler head 14.

In some embodiments, cam follower 36 may include a roller that is rotatably supported on arm 40. The roller may be rotatable about follower axis FA.

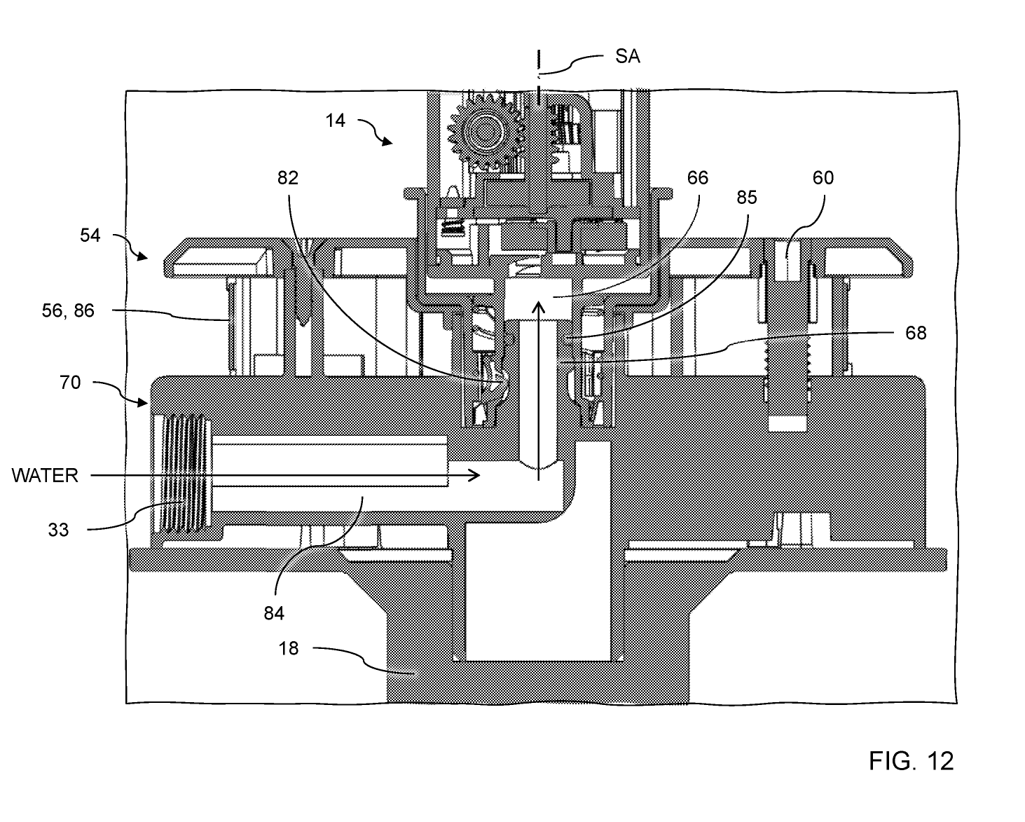

FIG. 12 is a schematic cross-sectional view through part of sprinkler head 14 and part of first docking station 12A taken along line 12-12 in FIG. 10. FIG. 12 shows the releasable coupling mechanism between sprinkler head 14 and first docking station 12A. In some embodiments, socket 66 and stem 68 may include one or more cooperating releasable interlocking features 82 (e.g., ridge, groove, detent) that permit the stem-and- socket coupling to click together upon installation and to be released only upon the actuation of a release mechanism and/or the manual application of a threshold axial force pulling sprinkler head 14 away from first docking station 12A along sprinkler axis SA.

In some embodiments, socket 66 and stem 68 may define a sealed liquid connection between first docking station 12A and sprinkler head 14 permitting water to be conveyed from connector 33 to nozzle 42 of sprinkler head 14 via water passage 84 defined in docking station 12A. Connector 33 may be connectable to hose 34 to permit water to be delivered from hose 34 into water passage 84. For example, an interface between socket 66 and stem 68 may include compressible seal 85, which may be an O- ring in some embodiments.

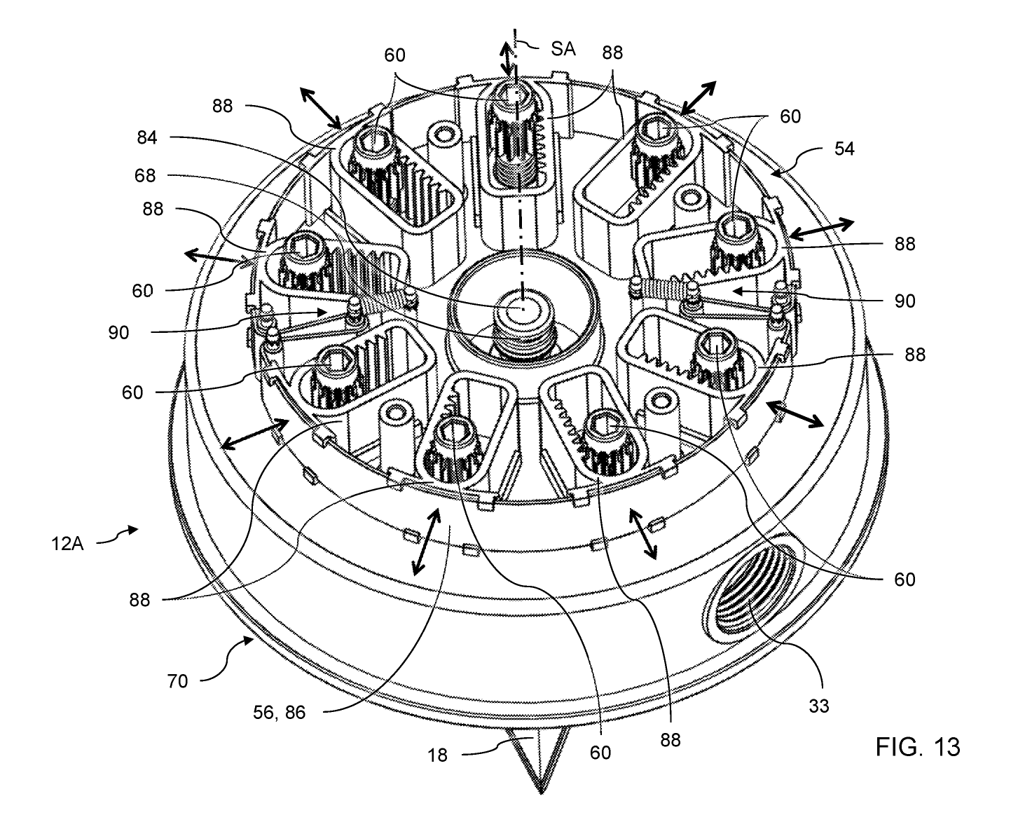

FIG. 13 is a perspective view of another exemplary docking station 12A with a top cover of controller 54 removed to expose the adjustment mechanism of cam surface 56. Cam surface 56 may have an adjustable radial profile providing the definition of first spray pattern 32A. Cam surface 56 may include (i.e., be defined by) belt 86 extending across a plurality of radially adjustable guides 88. Belt 86 may extend partially or completely around sprinkler axis SA and interact with guides 88 may define the trajectory of belt 86 to in turn define the profile of cam surface 56.

Belt 86 may include an elongated strip of flexible material such as a synthetic rubber compound for example. Belt 86 may be disposed radially outward of guides 88 relative to sprinkler axis SA. In some embodiments, controller 54 may include one or more (e.g., spring-loaded) tensioners 90 (referred hereinafter in the singular) engaged with belt 86 and configured to keep belt 86 taut and snug against guides 88.

The exemplary controller 54 shown in FIG. 13 includes nine guides 88 as an example but controller 54 may include fewer or additional guides 88 (e.g., 6-12 guides 88). In some embodiments, guides 88 may be evenly or unevenly spaced around sprinkler axis SA. FIG. 13 shows all guides 88 being retracted radially inward toward sprinkler axis SA. Each guide 88 may be translatable radially outward and radially inward independently of other guides 88 as shown by the radial arrows in FIG. 13.

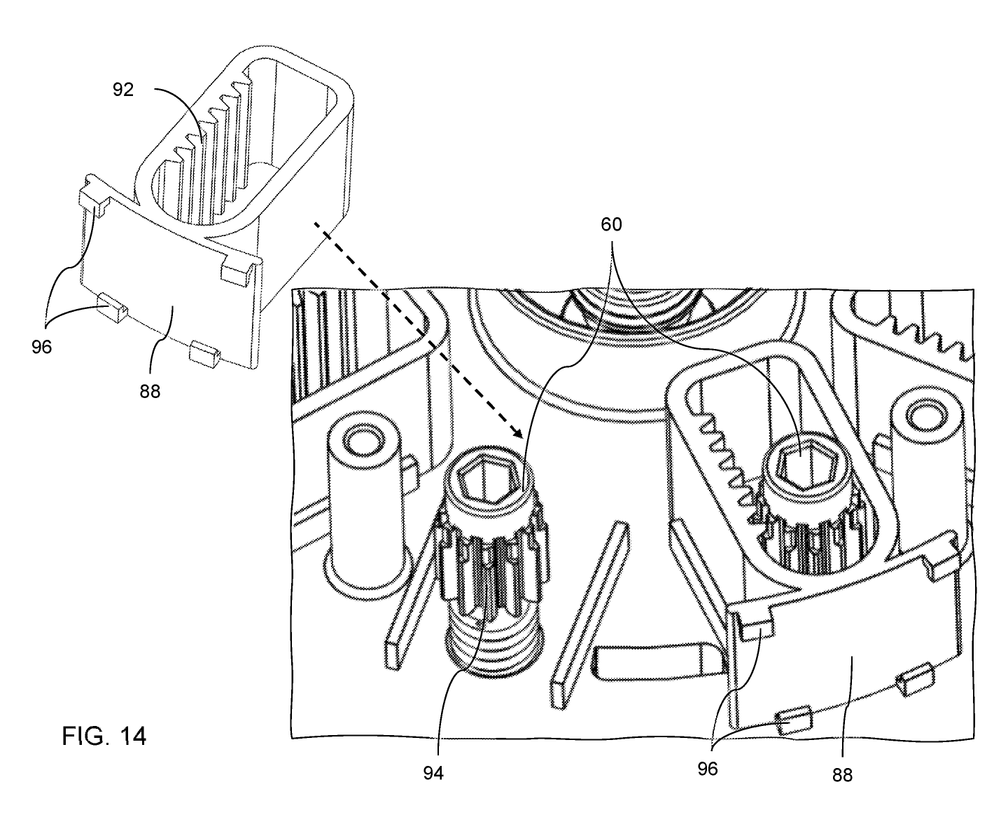

FIG. 14 is an enlarged perspective view of part of controller 54 of docking station 12A of FIG. 13 showing one of guides 88 removed for illustration purpose. Guide 88 may include an elongated slot through which bolt 60 may be received. Guide 88 may include linear gear 92 formed on an inner wall of guide 88 and meshed with pinion gear 94. Pinion gear 94 may be in torque-transmitting engagement with bolt 60 and coaxial with bolt 60. Linear gear 92 may be oriented substantially radially relative to sprinkler axis SA.

Pinion gear 94 may be manually rotatable with bolt 60 using driver 62 to cause a radial translation of guide 88 to adjust the profile of cam surface 56 defined by belt 86. Rotation of pinion gear 94 in one direction may cause radially outward translation of guide 88 relative to sprinkler axis SA. Rotation of pinion gear 94 in the opposite direction may cause radially inward translation of guide 88 relative to sprinkler axis SA. Movement of guide 88 radially outward may push a corresponding section of belt 86 radially outward against the tension provided by tensioner 90. Movement of guide 88 radially inward may release the corresponding section of belt 86 and cause the tension provided by tensioner 90 to pull the corresponding section of belt 86 radially inward. Bolts 60 may frictionally retain their respective angular positions after adjustment.

In some embodiments, guide 88 may be configured to permit some sliding angular movement of belt 86 about sprinkler axis SA relative to guide 88. The sliding angular movement of belt 86 relative to guide 88 may permit tensioner 90 to take-up slack in belt 86 as needed based on the adjustment of guides 88.

In some embodiments, guide 88 may be configured to hinder axial movement of belt 86 along sprinkler axis SA relative to guide 88. Guide 88 may include one or more retainers 96 configured to axially retain belt 86 relative to guide 88.

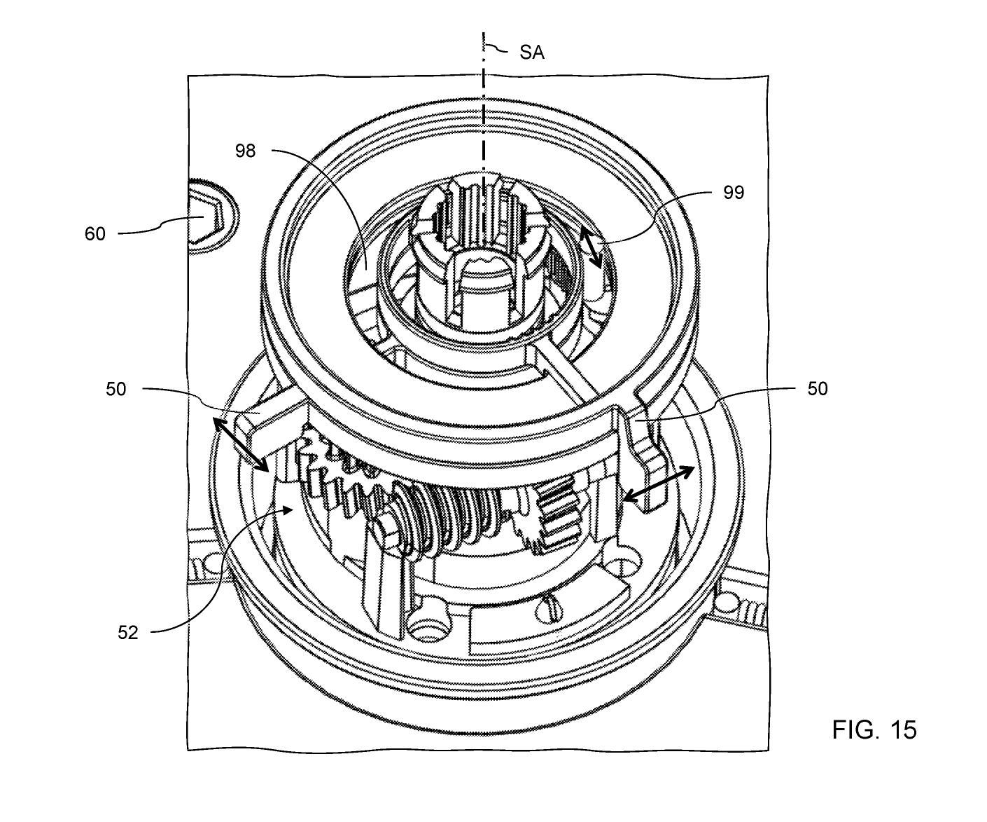

FIG. 15 is an enlarged perspective view of part of sprinkler head 14 of FIG. 10 including arc adjustment rings 50. The angular positions of arc adjustment rings 50 about sprinkler axis SA may be manually adjustable to set the limits of an angular span for first spray pattern 32A. One arc adjustment ring 50 may serve to set one limit of the angular span and the other arc adjustment ring 50 may server to set another (i.e., opposite) limit of the angular span. Arc adjustment rings 50 may frictionally retain their respective positions after adjustment.

Arc adjustment rings 50 may cooperatively define arcuate slot 98 extending around sprinkler axis SA. The angular length and position of slot 98 may be defined by the positions of arc adjustment rings 50. Slot 98 may receive pin 99 of drive mechanism 52 therein. During operation of sprinkler system 310, pin 99 may travel along slot 98 in a reciprocating manner from one end of slot 98 to the opposite end of slot 98 with the angular reciprocating movement of sprinkler head 14. When reaching the end of slot 98, pin 99 may actuate drive mechanism 52 to change the direction of rotation of sprinkler head 14.

The sprinkler systems described herein may be made from suitable material(s) and may include molded plastic and/or metallic components.

As can be seen therefore, the examples described above and illustrated are intended to be exemplary only. The scope is indicated by the appended claims.

What is claimed is:

1. A sprinkler system for irrigating zones with different spray patterns, the sprinkler system comprising:
a sprinkler head connectable to a water source, the sprinkler head including an interface for receiving: a first input causing the sprinkler head to irrigate with a first spray pattern; and a second input causing the sprinkler head to irrigate with a second spray pattern different from the first spray pattern;
a first controller storing the first input and being releasably connectable to the sprinkler head to provide the first input to the sprinkler head via the interface and cause the sprinkler head to irrigate with the first spray pattern during irrigation of a first zone; and
a second controller storing the second input and being releasably connectable to the sprinkler head to provide the second input to the sprinkler head via the interface and cause the sprinkler head to irrigate with the second spray pattern during irrigation of a second zone.

2. The sprinkler system as defined in claim 1, comprising:
a first base configured to hold the first controller at a first location for irrigating the first zone, the first base including a first anchor for engaging with a ground at the first location; and
a second base configured to hold the second controller at a second location for irrigating the second zone, the second base including a second anchor for engaging with a ground at the second location.

3. The sprinkler system as defined in claim 2, wherein:
the first base includes a platform including an upper side facing the first controller, and a lower side opposite the upper side; and
the first anchor includes a spike extending from the lower side of the platform.

4. The sprinkler system as defined in claim 2, wherein the first controller is releasably connectable to the first base.

5. The sprinkler system as defined in claim 2, wherein:
the sprinkler head is connectable to the water source via the first base when the first base is holding the first controller and the sprinkler head is releasably connected to the first controller; and
the sprinkler head is connectable to the water source via the second base when the second base is holding the second controller and the sprinkler head is releasably connected to the second controller.

6. The sprinkler system as defined in claim 1, wherein:
the interface of the sprinkler head includes a cam follower operable to adjust a spray distance of the sprinkler head;
the first input of the first controller includes a first cam surface for interacting with the cam follower of the sprinkler head; and
the second input of the second controller includes a second cam surface for interacting with the cam follower of the sprinkler head.

7. The sprinkler system as defined in claim 6, wherein the first cam surface of the first controller is manually adjustable to adjust the spray distance.

8. The sprinkler system as defined in claim 7, wherein the sprinkler head includes a
handle for manually adjusting the first cam surface of the first controller.

9. The sprinkler system as defined in claim 6, wherein:
the sprinkler head is rotatable about a sprinkler axis when the sprinkler head is releasably connected to the first controller; and
the first cam surface is radially adjustable relative to the sprinkler axis.

10. The sprinkler system as defined in claim 9, wherein:
the first controller includes a plurality of guides angularly spaced apart about the sprinkler axis, the guides being radially adjustable relative to the sprinkler axis; and
the first cam surface includes a belt extending at least partially around the sprinkler axis and interacting with the guides so that a profile of the first cam surface is defined by the guides.

11. The sprinkler system as defined in claim 10, wherein:
a first of the guides includes a linear gear; and
the first controller includes a manually rotatable pinion gear that is meshed with the linear gear to drive a radial translation of the first guide relative to the sprinkler axis.

12. The sprinkler system as defined in claim 1, wherein the sprinkler head includes arc adjustment rings defining an angular range of rotation of the sprinkler head.

13. A method of irrigating zones with different spray patterns, the method comprising:
irrigating a first zone with a sprinkler head while the sprinkler head is docked to a first docking station, the first docking station providing a first input to the sprinkler head to cause the sprinkler head to irrigate the first zone with a first spray pattern; and
irrigating a second zone with the sprinkler head while the sprinkler head is docked to a second docking station, the second docking station providing a second input to the sprinkler head to cause the sprinkler head to irrigate the second zone with a second spray pattern different from the first spray pattern.

14. The method as defined in claim 13, comprising adjusting the first input stored in the first docking station while the sprinkler head is docked to the first docking station using a user interface disposed on the sprinkler head.

15. The method as defined in claim 14, comprising adjusting the second input stored in the second docking station while the sprinkler head is docked to the second docking station using the user interface disposed on the sprinkler head.

16. The method as defined in claim 13, wherein the first input includes a cam surface
disposed on the first docking station for interacting with a cam follower of the sprinkler head.

17. A sprinkler system for irrigating a zone, the sprinkler system comprising:
a docking station configured for installation at a location associated with the zone, the docking station storing a definition of a spray pattern for irrigating the zone; and
a sprinkler head connectable to a water source and releasably connectable to the docking station, the sprinkler head including an interface operable to receive the definition of the spray pattern from the docking station to irrigate the zone with the sprinkler head according to the definition of the spray pattern.

18. The sprinkler system as defined in claim 17, wherein
the docking station includes an anchor for engaging with a ground; and
a controller storing the definition of the spray pattern.

19. The sprinkler system as defined in claim 18, wherein:
the docking station includes a platform including an upper side facing the controller, and a lower side opposite the upper side;
the anchor includes a spike extending from the lower side of the platform; and
the platform extends radially outwardly beyond the controller relative to the spike.

20. The sprinkler system as defined in claim 17, wherein:
the docking station includes a cam surface storing the definition of the spray pattern; and
the interface of the sprinkler head includes a cam follower for interacting with the cam surface of the docking station, the cam follower being operable to adjust a spray distance of the sprinkler head.

21. The sprinkler system as defined in claim 17, wherein the definition of the spray pattern stored in the docking station is adjustable via a user interface disposed on the sprinkler head.

22. The sprinkler system as defined in claim 17, wherein the sprinkler head is releasably connectable to the docking station via a stem and socket coupling.

23. The sprinkler system as defined in claim 17, wherein the docking station includes a cam surface having an adjustable profile providing the definition of the spray pattern, the cam surface including a belt extending across a plurality of guides, each of the guides including a linear gear meshed with a pinion gear, the pinion gear being rotatable to cause a translation of each of the guides to adjust the profile of the cam surface.
